(19) United States
(12) Patent Application Publication
(10) Pub. No.: US 2018/0178862 A1
(43) Pub. Date: Jun. 28, 2018

(54) MOUNTING PLATE ASSEMBLY

(71) Applicants: Ronald A. Vari, Burr Ridge, IL (US); John W. Reidl, Tinley Park, IL (US)

(72) Inventors: Ronald A. Vari, Burr Ridge, IL (US); John W. Reidl, Tinley Park, IL (US)

(21) Appl. No.: 15/855,679

(22) Filed: Dec. 27, 2017

Related U.S. Application Data
(60) Provisional application No. 62/498,419, filed on Dec. 27, 2016.

(51) Int. Cl. B62D 43/00; B62D 43/02

(52) U.S. Cl. CPC B62D 43/007; B62D 43/02

(57) ABSTRACT

An apparatus comprises a mounting plate configured to couple to a holder of an motor vehicle and a mounting arm integrally formed with the mounting plate to receive a motor vehicle tire. The apparatus further comprises a plurality of gaskets to couple to the mounting plate at the mounting arm. Additionally, the apparatus comprises a puck lock to couple to the mounting plate at the mounting arm.

### PRIORITY CLAIM

This application claims priority to Provisional Patent No. 62/498,419, filed Dec. 27, 2016.

### BACKGROUND

Motor vehicles may come equipped with a spare tire for use in the event of a flat tire. In some examples, the spare tire may be mounted on a rear end of the motor vehicle on, for example, a trunk of the vehicle. A spare tire that is located on a rear end of a motor vehicle may be susceptible to theft due to the relative ease of access to the tire.

### BRIEF DESCRIPTION OF THE DRAWINGS

FIG. 1 is an example mounting assembly for a mounting plate assembly consistent with the present disclosure.

FIG. 2 is an example gasket for a mounting plate assembly consistent with the present disclosure.

FIG. 3 is an example puck lock for a mounting plate assembly consistent with the present disclosure.

FIG. 4 is another example mounting assembly for a mounting plate assembly consistent with the present disclosure.

### DETAILED DESCRIPTION

Motor vehicles may rely on tires for movement. Due to the material making up the tire (e.g., rubber), a tire may experience incidents, such as punctures, that lead to the air contained within the tire being released. This may be referred to as a “flat” tire or simply a “flat”. In order to continue traveling by a motor vehicle when a flat has occurred, the flat tire should be removed and a different, non-flat, tire should be installed. To this end, many motor vehicles come equipped with a spare tire. The spare tire may be retrieved in the event of a flat and installed in place of the flat tire to allow continued use of the motor vehicle.

A spare tire may be contained within the motor vehicle itself. For example, a spare tire may be located underneath the carriage of the motor vehicle or may be housed in a well designed to hold the spare tire. In some motor vehicles, however, the spare tire may be located on an outer surface of the vehicle itself. For example, the spare tire may be located on a trunk door of the vehicle, although examples are not so limited. In such examples, the spare tire may be coupled to the motor vehicle by a plurality of bolts and nuts, although other mounting mechanisms may be utilized.

A spare tire located on the outside of a vehicle may provide ease of access to the tire in the event of a flat (thus rendering the spare tire useful); however, the ease of access to the spare tire may also render the spare tire more susceptible to theft. Moreover, because a spare tire located on an outside surface of a motor vehicle may lack a cabling attachment system (such as the system often used to attach spare tires to an underside of a motor vehicle), a potential thief may target a spare tire located on the outside of a vehicle as the tire that may be easier to remove than other spare tires stowed elsewhere.

Accordingly, the present disclosure relates to an apparatus for a spare tire to prevent or deter theft thereof. A mounting plate may be coupled to a holder of a motor vehicle. The mounting plate may include a mounting arm to receive the spare tire, as well as to receive additional components, such as a gasket and/or a disc. A puck lock may further be coupled to the mounting arm to “lock” the spare tire into place on the apparatus.

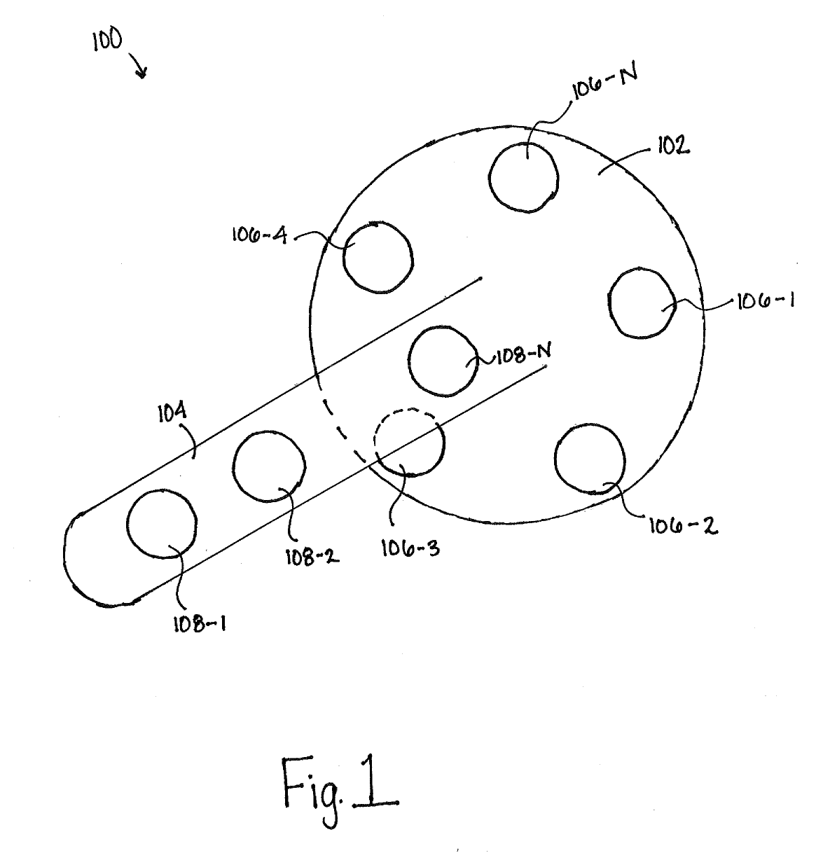

FIG. 1 is an example of a mounting assembly 100 for a mounting plate assembly consistent with the present disclosure. Assembly 100 may include a mounting plate 102. As shown in FIG. 1, mounting plate 102 may be substantially circular in shape, although examples are not so limited. Mounting plate 102 may include an integrally formed mounting arm 104. As used herein, a mounting arm refers to a protrusion designed to receive components including, for example, a spare tire. Mounting arm 104 may be integrally formed with mounting plate 102. That is, mounting arm 104 may be formed as part of mounting plate 102. In some examples, mounting arm 104 may extend from mounting plate 102 in a substantially perpendicular direction, although examples are not so limited. Mounting arm 104 may be disposed substantially perpendicularly with respect to the mounting plate 102 such that the mounting arm 104 is exposed when the mounting plate 102 is coupled to a holder of the motor vehicle. That is, the mounting arm may extend outwardly from the mounting plate 102 when the mounting plate 102 is coupled to the motor vehicle. Moreover, although FIG. 1 shows mounting arm 104 located in a substantially central area of mounting arm 102, examples are not so limited and the mounting arm 104 may be located at any location relative to mounting plate 102. Mounting plate 102 and mounting arm 104 may be fabricated of a metal, such as steel, although examples are not so limited.

Mounting plate 102 may include a plurality of apertures 106-1, 106-2, 106-3, 106-4 . . . 106-N (collectively, apertures 106). As used herein, an aperture refers to an opening or hole designed to have an object pass through or to receive an object. Apertures 106 may permit mounting plate 102 to couple with a holder of a motor vehicle. As used herein, a holder refers to a structure on a motor vehicle to receive and retain a spare tire. The holder may include a plurality of bolts, such that the spare tire is retained on the holder by the plurality of bolts. Apertures 106 may be disposed on mounting plate 102 such that mounting plate 102 is able to couple with the holder at the bolts. That is, the locations of apertures 106 on mounting plate 102 may correspond to the locations of bolts located on the holder such that mounting plate 102 may couple with the holder through insertion of the bolts through the apertures 106. Assembly 100 may further include a plurality of washers (not shown). As used herein, a washer refers to a ring designed to be placed under or between a bolt and/or a nut to provide additional sealing and/or to assist in spreading pressure when the nut and/or bolt is tightened. The plurality of washers may be coupled to the bolts after the mounting plate 102 is coupled to the bolts at apertures 106. That is, mounting plate 102 may be coupled to the bolts at apertures 106 first, with the washers being coupled to the bolts subsequently.

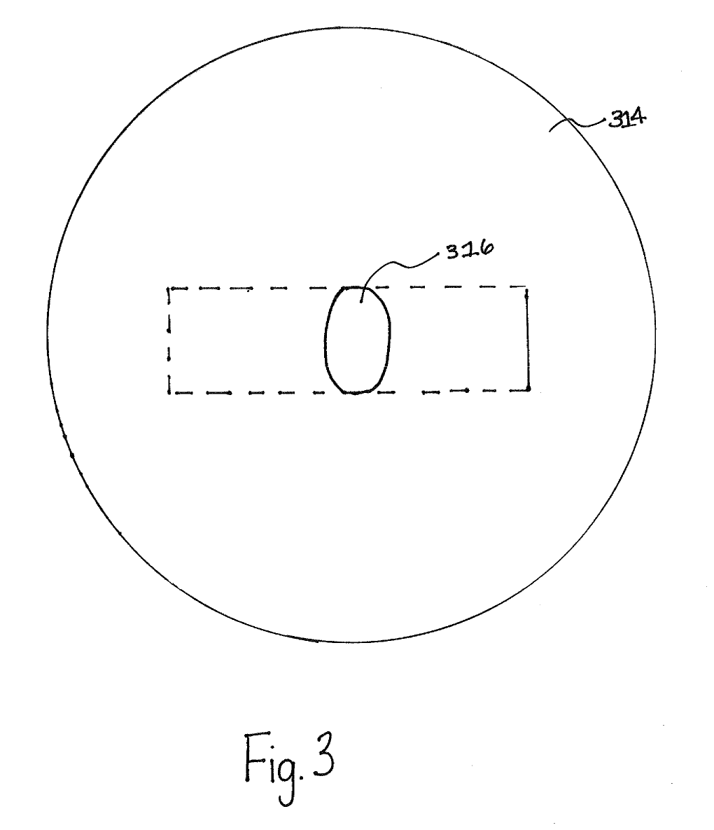

Mounting arm 104 may also include a plurality of apertures 108-1, 108-2 . . . 108-N (collectively, apertures 108). As shown in FIG. 1, apertures 108 may be disposed along a length of mounting arm 104, although examples are not so limited. Apertures 108 may be configured to engage with additional components of assembly 100. For example, apertures 108 may be configured to engage with a puck lock (not shown in FIG. 1). The puck lock is further discussed herein with respect to FIG. 3.

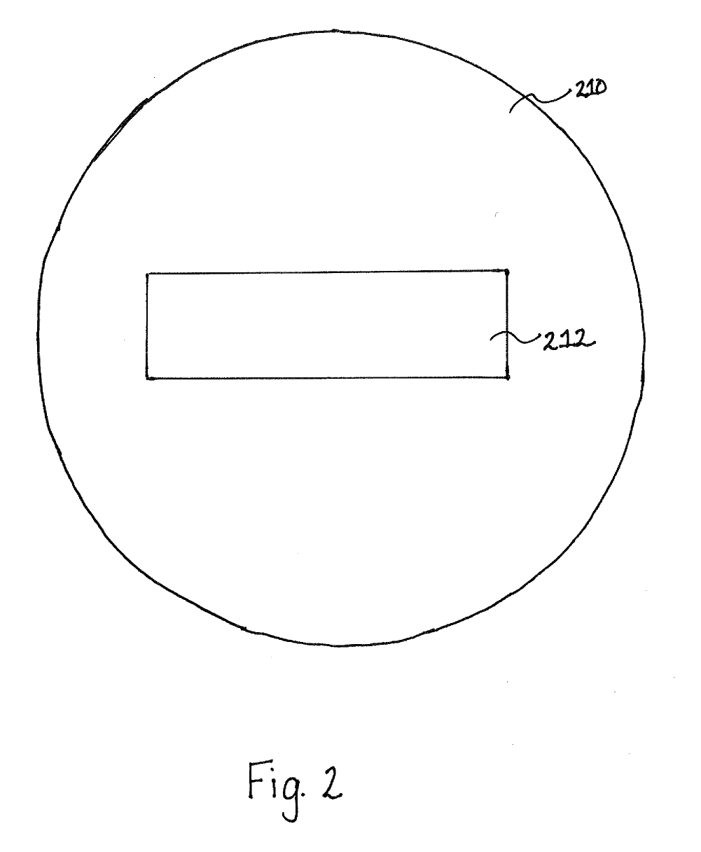

FIG. 2 is an example gasket 210 for a mounting plate assembly consistent with the present disclosure. As used herein, a gasket refers to a piece of rubber or a similar material designed to create a seal between two surfaces, as well as provide protection between the two surfaces. Although FIG. 2 shows a single gasket 210, examples are not so limited and the mounting plate assembly may include a plurality of gaskets. Moreover, the plurality of gaskets may not be identical in size. For example, a first gasket may have a first diameter and a second gasket may have a second diameter that is different than the first diameter. Additionally, while gasket 210 is substantially circular in shape, examples are not so limited and gasket 210 may be any suitable shape. Gasket 102 may be fabricated from rubber, plastic, or metal, although examples are not so limited.

Gasket 210 may include an opening 212. Opening 212 may be disposed within gasket 210 such that gasket 210 may engage with mounting plate 102 at mounting arm 104 (discussed with respect to FIG. 1). Moreover, opening 212 may be shaped such that mounting arm 104 is able to receive gasket 210 at opening 212 without substantial difficulty. That is, opening 212 may be shaped so as to facilitate easy installation of gasket 210 onto mounting arm 104. Although opening 212 is shown to be rectangular in shape in FIG. 2, examples are not so limited and opening 212 may take any shape. Gasket 210 may be coupled to mounting plate 102 after mounting plate 102 is coupled to the holder of the automobile. In some examples, gasket 210 may be sized to be substantially identical in diameter to the mounting plate 102. In such examples, gasket 102 may provide protection from the bolts for any additional components of the mounting assembly, including the spare tire.

FIG. 3 is an example puck lock 314 for a mounting plate assembly consistent with the present disclosure. As used herein, a puck lock refers to a particular style of lock that lacks an external shackle but has an internal shackle surrounded by a casing. A puck lock such as puck lock 314 may include an opening to receive a key (not shown in FIG. 3), which may engage the internal shackle. Puck locks, such as puck lock 314, may be formed as a single unit; that is, puck lock 314 may be comprised of a single piece of material. Puck lock 314 may be substantially circular in shape, although examples are not so limited.

Puck lock 314 may include an opening 316. Opening 316 may be configured to permit puck lock 314 to engage with mounting arm 104 (discussed with respect to FIG. 1). That is, puck lock 314 may be inserted onto mounting arm 104 at opening 316. In operation, puck lock 314 may be coupled with mounting arm 104 after a spare tire is coupled to mounting arm 104. That is, puck lock 314 may be used to “lock” a spare tire onto the mounting arm 104.

To lock a spare tire onto the mounting arm 104, puck lock 314 may engage with the mounting arm 104 at an aperture 108 of the mounting arm 104. As described with respect to FIG. 1, apertures 108 may be disposed along a length of mounting arm 104. When puck lock 314 is installed on mounting arm 104, the opening of mounting arm 316 may be aligned or substantially aligned with an aperture 108. As a result, puck lock 314 may be “locked” to the mounting arm 104 at aperture 108. As described previously, a spare tire may be located on the mounting arm behind the installed puck lock 314. Therefore, engaging puck lock 314 with an aperture 108 may result in the spare tire being locked onto the mounting arm 104 such that the spare tire may not be removed without removal of the puck lock 314.

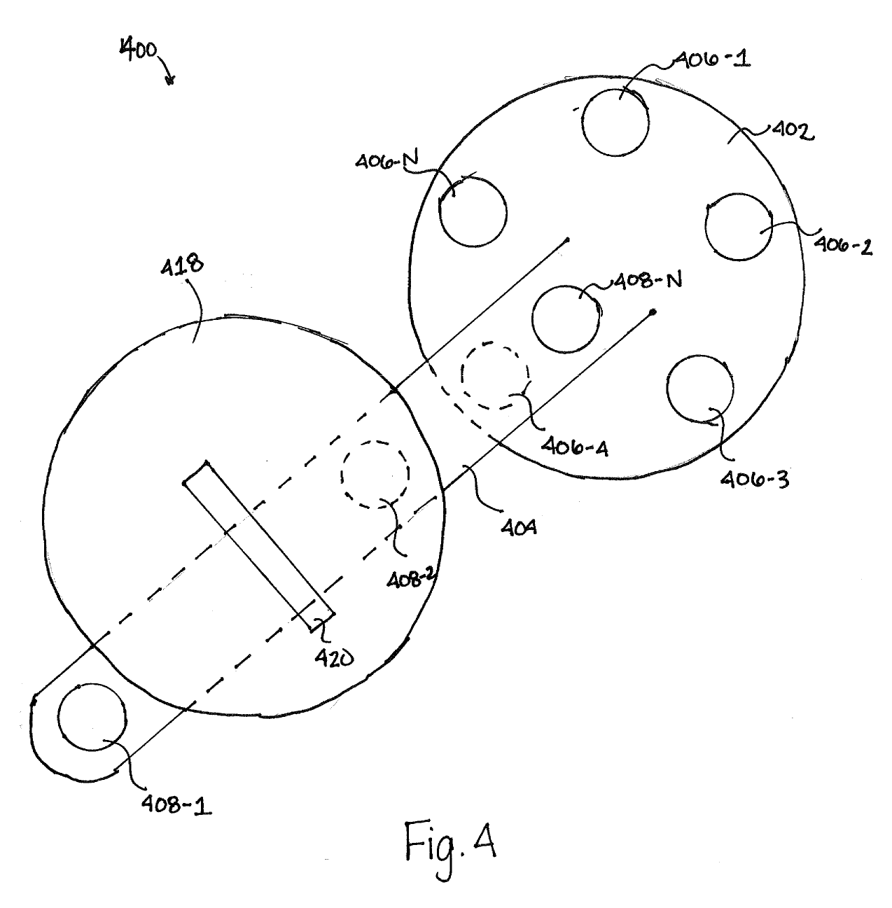

FIG. 4 is another example mounting assembly 400 for a mounting plate assembly consistent with the present disclosure. Mounting plate assembly 400 may include a mounting plate 402. Mounting plate 402 may be akin to mounting plate 102, described with respect to FIG. 1. Mounting assembly 400 may further include a mounting arm 404. Mounting arm 404 may be akin to mounting arm 104 described with respect to FIG. 1. As shown in FIG. 4 (and described with respect to FIG. 1), mounting arm 404 may extend from mounting plate 402 in a substantially perpendicular direction.

Mounting plate 402 may include a plurality of apertures 406-1, 406-2, 406-3, 406-4 . . . 406-N (collectively, apertures 406). Apertures 406 may be akin to apertures 106, discussed with respect to FIG. 1. As described with respect to FIG. 1, apertures 406 may be disposed around an edge of mounting plate 402 such that mounting plate 402 may couple with a holder of a motor vehicle (not shown in FIG. 4) at a plurality of bolts (not shown in FIG. 4). Mounting assembly 400 may further include a plurality of washers (not shown in FIG. 4) to assist in coupling the mounting plate 402 to the holder of the motor vehicle at the bolts. Apertures 406 may receive the bolts of the holder; that is, mounting plate 402 may be “pushed” onto the holder at the bolts by aligning the bolts with apertures 406 such that mounting plate 402 may be coupled to the holder. The washers may then be coupled with the bolts. In some examples, the washers may aid in preventing the mounting plate 402 from moving with respect to the bolts while additional components of mounting assembly 400 are installed.

Mounting arm 404 may include a plurality of apertures 408-1, 408-2 . . . 408-N (collectively, apertures 408). Apertures 408 may be akin to apertures 108 discussed with respect to FIG. 1. Apertures 408 may be disposed along a length of mounting arm 404, although examples are not so limited. As described with respect to FIG. 1, apertures 408 may engage with additional components of mounting assembly 400, such as puck lock 314, described with respect to FIG. 3.

Mounting assembly 400 may further include a plurality of gaskets, such as gasket 210 discussed with respect to FIG. 2. As described previously, each gasket of the plurality of gaskets may couple to the mounting plate at the mounting arm by an opening in the gasket. That is, a gasket such as gasket 210 may be received by the mounting arm 404 through an opening, such as opening 212. Once received by mounting arm 404, the gasket may be pushed against the mounting plate 402. As described with respect to FIG. 2, the gasket may contact the mounting plate and/or the bolts of the holder so as to provide additional protection from the mounting plate and/or bolts for additional components of mounting assembly 400.

Mounting assembly 400 may include a disc 418. As used herein, a disc refers to a substantially circular plate. Disc 418 may be metal, rubber, plastic, or any other suitable material. As shown in FIG. 4, disc 418 may engage with mounting arm 404. In some examples, disc 418 may engage with mounting arm 404 at an opening 420 of the disc 418. Although opening 420 is shown to be rectangular in shape, examples are not so limited, and opening 420 may be any suitable shape.

Disc 418 may be coupled with mounting arm 404 subsequent to the gasket, such as gasket 210. As previously described, the gasket may be pushed onto mounting arm 404 such that the gasket contacts mounting plate 402. Disc 418 may then be pushed onto mounting arm 404 and moved along the length of mounting arm 404 such that disc 418 contacts the gasket. In some examples, a second gasket may be engaged to contact disc 418, such that disc 418 has a first gasket in contact with a first side and a second gasket in contact with a second side.

Upon installation of the first and second gaskets and disc 418, a spare tire (not shown in FIG. 4) may be coupled to mounting arm 404. Similar to the gaskets and disc 418, the spare tire may be slid or pushed onto mounting arm 404. The spare tire may further be moved down mounting arm 404 until the spare tire contacts disc 418 or, if a second gasket is used, until the spare tire contacts the second gasket.

Mounting assembly 400 may further include a puck lock, such as puck lock 314 described with respect to FIG. 3. As described with respect to FIG. 3, the puck lock may engage with apertures 408 of mounting arm 404 such that the puck lock renders immovable the spare tire and the additional components of mounting assembly 400, such as gaskets and disc 418, without removal of the puck lock. The puck lock may be installed onto mounting arm 404 by an opening in the puck lock, such as opening 316, discussed with respect to FIG. 3. Upon installation of the puck lock onto mounting arm 404, the puck lock may be moved down the length of the mounting arm 404 until the puck lock contacts the spare tire. The location at which the puck lock contacts the spare tire may correspond to an aperture 408, such that the puck lock may be engaged with the mounting arm 404 at aperture 408.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structure changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and relative scale of the elements provided in the figures are intended to illustrate the examples of the present disclosure, and should not be taken in a limiting sense. Further, as used herein, “a number of” an element and/or feature can refer to one or more or such elements and/or features.

We claim:

1. An apparatus comprising:
a mounting plate configured to couple to a holder of an motor vehicle;
a mounting arm integrally formed with the mounting plate to receive a motor vehicle tire;
a plurality of gaskets to couple to the mounting plate at the mounting arm; and
a puck lock to couple to the mounting plate at the mounting arm.

2. The apparatus of claim 1, wherein the mounting plate includes a plurality of apertures to couple with a plurality of bolts on the holder of the motor vehicle.

3. The apparatus of claim 2, further comprising a plurality of washers to couple the mounting plate to the holder of the motor vehicle at the plurality of bolts of the motor vehicle.

4. The apparatus of claim 1, wherein the mounting arm extends perpendicularly from the mounting plate such that the mounting arm is exposed when the mounting plate is coupled to the motor vehicle holder.

5. The apparatus of claim 1, wherein the mounting arm includes a plurality of apertures to engage the puck lock.

6. The apparatus of claim 1, wherein each gasket of the plurality of gaskets includes an opening to engage the mounting arm.

7. The apparatus of claim 1, wherein the plurality of gaskets include a gasket having a first diameter and a gasket having a second diameter that is different than the first diameter.

8. The apparatus of claim 1, wherein the puck lock includes an opening to engage the mounting arm.

9. The apparatus of claim 8, wherein the puck lock is to engage an aperture of the mounting arm at the opening of the puck lock.

10. An apparatus, comprising:
a mounting plate configured to couple to a holder of an motor vehicle;
a mounting arm integrally formed with the mounting plate to receive a motor vehicle tire;
a plurality of gaskets to couple to the mounting plate at the mounting arm;
a disc to couple to the mounting plate at the mounting arm; and
a puck lock to couple to the mounting plate at the mounting arm.

11. The apparatus of claim 10, further comprising a plurality of washers to couple the mounting plate to the holder of the motor vehicle at a plurality of bolts of the holder, wherein the mounting plate further comprises a plurality of apertures to receive the plurality of bolts and the plurality of washers.

12. The apparatus of claim 10, wherein:
each gasket of the plurality of gaskets includes an opening to receive the mounting arm; and
the disc includes an opening to receive the mounting arm.

13. The apparatus of claim 10, wherein the mounting arm includes a plurality of apertures to couple with the puck lock.

14. The apparatus of claim 10, wherein the puck lock includes an opening to receive the mounting arm.

15. The apparatus of claim 14, wherein the puck lock is to engage an aperture of the mounting arm at the opening of the puck lock.
